(19) United States
(12) Patent Application Publication
(10) Pub. No.: US 2010/0328874 A1
(43) Pub. Date: Dec. 30, 2010

(54) FOLDABLE USB FLASH MEMORY DEVICE

(75) Inventor: CHUN-CHENG KO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/616,877

(22) Filed: Nov. 12, 2009

(30) Foreign Application Priority Data
Jun. 26, 2009 (CN) 200910303764.7

(51) Int. Cl. G06F 1/16

(52) U.S. Cl. 361/679.32

(57) ABSTRACT

An exemplary USB flash memory device includes a main body, a bending portion, a memory unit, and a connector. The main body includes a front wall, a back wall, and two side walls between the front and back walls. A transverse width of each of the front wall and the back wall is larger than a transverse width of each side wall. The bending portion is pivotably connected to the main body, a rotation axis of the bending portion is substantially perpendicular to the front wall and the back wall of the main body. The memory unit is received in the main body. The connector is electrically connected to the memory unit, the connector is secured to an end of the bending portion farthest away from the main body.

### BACKGROUND

1. Technical Field

The present disclosure relates to universal serial bus (USB) flash memory devices and, particularly, to a foldable USB flash memory device which has a bending portion.

2. Description of Related Art

In order to store data into or read data from a USB flash memory device, the USB flash memory device needs to be inserted into a USB port of a device such as a computer. When a conventional USB flash memory device is inserted into a USB port located on a surface of a computer, the device sticks out perpendicularly from the computer. Because the length of the USB flash memory device is typically about 10 centimeters (cm), the USB flash memory device is easily struck accidentally. Even a slight impact may cause the USB flash memory device and/or the USB port to be damaged.

What is needed, therefore, is a USB flash memory device to overcome or at least mitigate the above-described problems.

### BRIEF DESCRIPTION OF THE DRAWINGS

Many aspects of the present USB flash memory device can be better understood with reference to the accompanying drawings. The components in the drawings are not necessarily drawn to scale, the emphasis instead being placed upon clearly illustrating the principles of the present USB flash memory device. In the drawings, all the views are schematic.

FIG. 1 is an exploded, isometric view of a USB flash memory device according to an exemplary embodiment.

FIG. 2 is an assembled view of the USB flash memory device of FIG. 1.

FIG. 3 is similar to FIG. 2, but showing the USB flash memory device bent.

FIG. 4 is a plan view of the USB flash memory device of FIG. 3 in use with an electronic device.

### DETAILED DESCRIPTION

Embodiments of the present disclosure will now be described in detail below, with reference to the accompanying drawings.

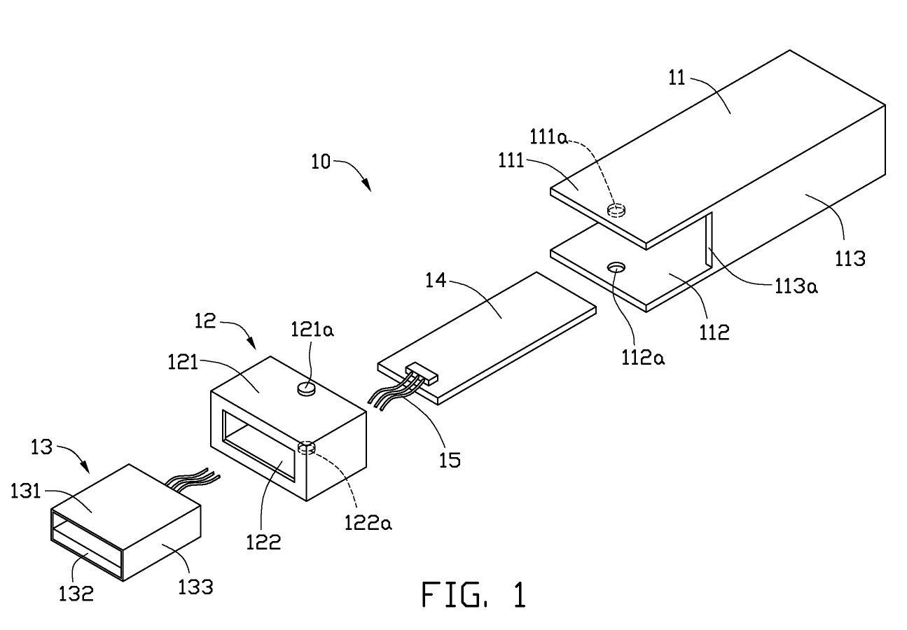

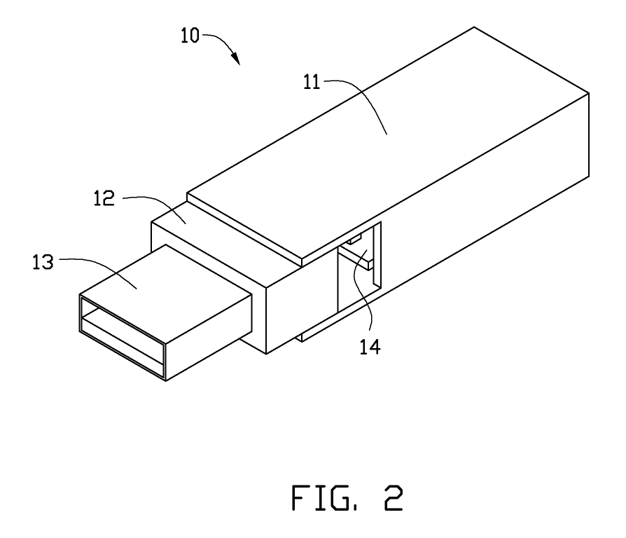

Referring to FIGS. 1 and 2, a USB flash memory device 10, according to an exemplary embodiment, is shown. The USB flash memory device 10 includes a main body 11, a bending portion 12, a connector 13, a memory unit 14, and a number of cables 15.

The main body 11 includes a front wall 111, a back wall 112, and two opposite side walls 113. A transverse width of the front wall 111 and a transverse width of the back wall 112 are larger than a transverse width (i.e. the height) of each side wall 113. In the present embodiment, the side walls 113 are shorter than the front wall 111 and the back wall 112. Thereby, the main body 11 defines a pair of cutouts 113a at ends of the side walls 113, respectively. The cutouts 113a provide room for the bending portion 12 to rotate within the main body 11. The front wall 111 defines a first pivot hole 111a in an end thereof between the cutouts 113a. The back wall 112 defines a second pivot hole 112a in an end thereof between the cutouts 113a. The first and second pivot holes 111a, 112a are aligned with each other. The first and second pivot holes 111a, 112a can be blind holes or through holes. In the illustrated embodiment, the first and second pivot holes 111a, 112a are blind holes.

The bending portion 12 is received between the front wall 111 and the back wall 112 of the main body 11. The bending portion 12 includes a front wall 121 and a back wall 122. The bending portion 12 is pivotably connected to the main body 11. In the present embodiment, the front wall 121 includes a first protrusion 121a, and the back wall 122 includes a second protrusion 122a. The first protrusion 121a and the second protrusion 122a are received in the first pivot hole 111a and the second pivot hole 112a, respectively. Thereby, the bending portion 12 is rotatable relative to the main body 11 around a rotation axis that is substantially perpendicular to the front wall 121 and the back wall 122.

The connector 13 is secured to an end of the bending portion 12 farthest away from the main body 11. The connector 13 includes a front wall 131, a back wall 132, and two side walls 133. The front wall 131 and the back wall 132 are parallel to the front wall 111 of the main body 11, and the side walls 133 are parallel to the side walls 113 of the main body 11. A transverse width of each of the front wall 131 and the back wall 132 is larger than that of each of the side walls 133.

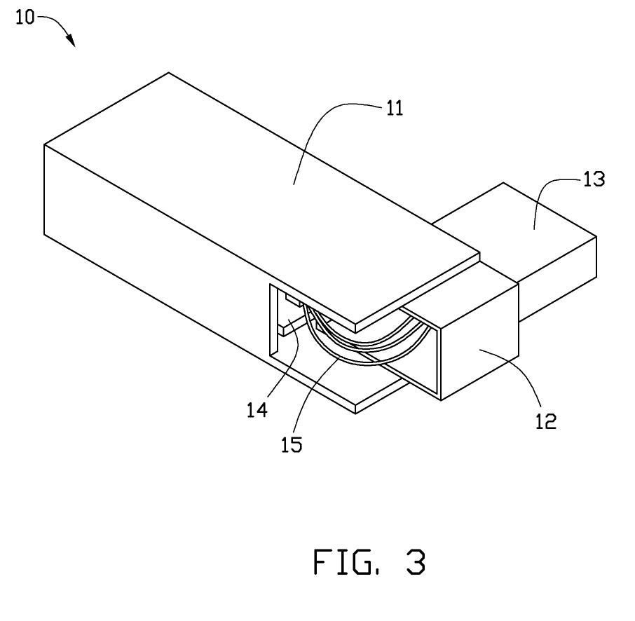

The memory unit 14 is received in the main body 11, and is for storing data. The connector 13 is electrically connected to the memory unit 14 via the cables 15. Referring also to FIG. 3, the length of the cables 15 is greater than the distance between the connector 13 and the memory unit 14. Therefore, the connector 13 can remain reliably connected to the memory unit 14 when the bending portion 12 is rotated or folded.

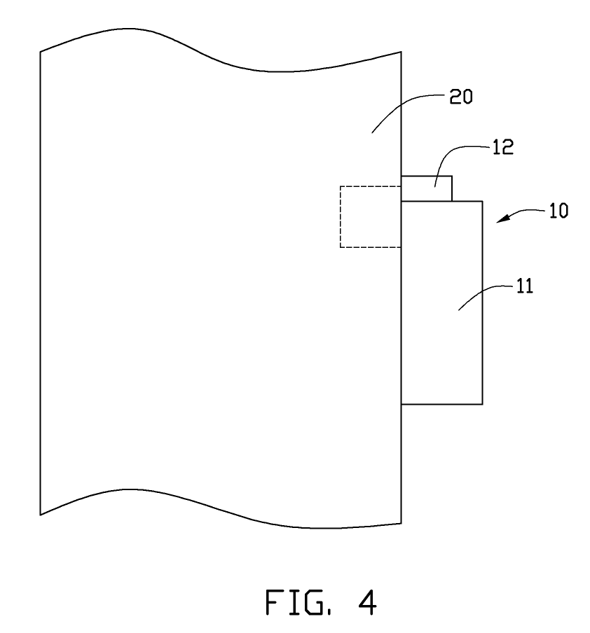

Referring also to FIG. 4, this shows the connector 13 of the USB flash memory device 10 inserted into a USB port (not labeled) of an electronic device 20. The main body 11 can be rotated relative to the bending portion 12 so that one of the side walls 133 of the main body 11 abuts against a surface of the electronic device 20. Thereby, the USB flash memory device 10 is held close to the electronic device 20 and sticks out from the electronic device 20 as little as possible. In this position, the USB flash memory device 10 is minimally prone to damage due to accidental collisions. Thus, the USB flash memory device 10 can remain intact.

While certain embodiments have been described and exemplified above, various other embodiments will be apparent to those skilled in the art from the foregoing disclosure. The invention is not limited to the particular embodiments described and exemplified, and the embodiments are capable of considerable variation and modification without departure from the scope and spirit of the appended claims.

What is claimed is:

1. A universal serial bus (USB) flash memory device comprising:
a main body comprising a front wall, a back wall, and two side walls between the front and back walls, a transverse width of each of the front wall and the back wall being larger than a transverse width of each side wall;
a bending portion pivotably connected to the main body, a rotation axis of the bending portion being substantially perpendicular to the front wall and the back wall of the main body;
a memory unit received in the main body; and
a connector electrically connected to the memory unit, the connector being secured to an end of the bending portion farthest away from the main body.

2. The USB flash memory device of claim 1, wherein the main body defines a pair of cutouts at a pair of ends of the side walls, respectively.

3. The USB flash memory device of claim 2, wherein the front wall defines a first pivot hole in an end thereof between the cutouts, and the back wall defines a second pivot hole aligned with the first pivot hole in an end thereof between the cutouts; and the bending portion comprises two opposite walls each comprising a protrusion, the protrusions engaging in the first pivot hole and the second pivot hole, respectively.

4. The USB flash memory device of claim 1, wherein the first pivot hole is one of a blind hole and a through hole.

5. The USB flash memory device of claim 1, wherein the second pivot hole is one of a blind hole and a through hole.

6. The USB flash memory device of claim 1, wherein the connector comprises a front wall, a back wall, and two side walls, the front wall and the back wall of the connector are parallel to the front wall and the back wall of the main body, and the side walls of the connector are parallel to the side walls of the main body.

7. The USB flash memory device of claim 6, wherein a transverse width of each of the front wall and the back wall of the connector is larger than that of each of the side walls of the connector.

8. The USB flash memory device of claim 1, wherein the connector is electrically connected to the memory unit via a plurality of cables.

9. The USB flash memory device of claim 8, wherein the length of the plurality of cables is greater than the distance between the connector and the memory unit.

10. A universal serial bus (USB) flash memory device comprising:
a main body capable of receiving a memory therein, the main body comprising a front wall, a back wall, and two opposite side walls, a transverse width of the each of the front wall and the back wall being larger than a transverse width of each side wall;
a bending portion pivotably connected to the main body, the rotation axis of the bending portion being substantially perpendicular to the front wall and the back wall of the main body; and
a connector capable of electrically connecting to the memory unit, the connector being secured to an end of the bending portion farthest away from the main body.

11. The USB flash memory device of claim 10, wherein the main body defines a pair of cutouts at a pair of ends of the side walls, respectively.

12. The USB flash memory device of claim 11, wherein the front wall defines a first pivot hole in an end thereof between the cutouts, and the back wall defines a second pivot hole aligned with the first pivot hole in an end thereof between the cutouts; and the bending portion comprises two opposite walls each comprising a protrusion, the protrusions engaging in the first pivot hole and the second pivot hole, respectively.

13. The USB flash memory device of claim 10, wherein the first pivot hole is one of a blind hole and a through hole.

14. The USB flash memory device of claim 10, wherein the second pivot hole is one of a blind hole and a through hole.

15. The USB flash memory device of claim 10, wherein the connector comprises a front wall, a back wall, and two side walls, the front wall and the back wall of the connector are parallel to the front wall and the back wall of the main body, and the side walls of the connector are parallel to the side walls of the main body.

16. The USB flash memory device of claim 15, wherein a transverse width of each of the front wall and the back wall of the connector is larger than that of each of the side walls of the connector.

17. The USB flash memory device of claim 10, wherein the connector is electrically connected to the memory unit via a plurality of cables.

18. The USB flash memory device of claim 17, wherein the length of the plurality of cables is greater than the distance between the connector and the memory unit.
